(19) United States
(12) Patent Application Publication
(10) Pub. No.: US 2006/0257527 A1
(43) Pub. Date: Nov. 16, 2006

(54) Process for the enzymatic preparation of vanilla flavor

(76) Inventors: Cesare Ponzone, Milano (IT); Marco Bertani, Abbiategrasso (IT)

Correspondence Address: YOUNG & THOMPSON, 745 SOUTH 23RD STREET, 2ND FLOOR, ARLINGTON, VA, 22202, US

(21) Appl. No.: 10/553,184

(22) PCT Filed: Dec. 22, 2003
(86) PCT No.: PCT/EP03/14702

§ 371 Date: Jul. 2, 2006

(30) Foreign Application Priority Data
Apr. 15, 2003 (IT) MI2003A 000778

(51) Int. Cl. A23F 3/16

(52) U.S. Cl. 426/52

(57) ABSTRACT

The invention relates to a process for the preparation of a vanilla extract, which process consists in subjecting vanilla green beans to accelerated browning followed by extractive/enzymatic treatment.

The present invention relates to a novel process for the preparation of vanilla flavor.

Vanilla flavor is the result of a balanced mixture of organic substances, contained in the bean of an orchid, Vanilla planifolia.

More particularly, the main compound, vanillin, is formed starting from its glucosylated precursor (glucovanillin) during maturation of the beans following natural enzymatic hydrolysis by the enzymes present in the bean.

Conventional processes for the extraction of vanillin involve therefore a curing period, which requires long times (one to five months, depending on the harvesting site), a number of time-prolonged quality controls and is deeply affected by the environmental conditions. As a consequence, this involves marked variability in the final product and partial loss of the vanillin content. Therefore this process is very expensive from the industrial standpoint.

EP 0 555 466 discloses a process alternative to traditional curing, which consists in the treatment of the suitably ground green beans with hydrolase enzymes (cellulases, pectinases, β-glucosydase) which act both by lysing the bean planttissues, thus promoting the extraction of the active ingredient, while hydrolyzing the released glucovanillin into vanillin.

The present invention relates to a process for the preparation of a vanilla extract, which consists in subjecting the vanilla green beans to a combined treatment of extraction and subsequent enzymatic lysis of the resulting extract with an enzyme system with high overall lytic activity.

According to the invention, the process is free from the restrictions of the industrial processes known at present, both in terms of time (months-long incubation) and environment and at the same time provides a vanillin-enriched product in high yields. The process of the invention involves therefore remarkable advantages in terms of easiness, shortness, reproducibility and yields compared with the known processes.

The process of the invention comprises the following steps:

a) accelerated browning of the beans;

b) extraction of the browned beans followed by treatment with an enzymatic system containing cellulase and hemicellulase activities;

c) purification of the products to obtain a vanillin-enriched concentrate.

The accelerated browning of the beans, step a), consists in freezing the green beans at temperatures ranging from −10° to −30° C. and subsequently thawing at temperatures ranging from 2° to 8° C., preferably at 4° C., shielding from light, for the time necessary to attain the desired temperature, which time usually ranges from 0.5 to 7 days.

Alternatively, the accelerated browning of the beans, step a), can consist in scalding the green beans by soaking them for 3 minutes in water, at temperatures ranging from 60° to 65° C., and subsequently incubating them at temperatures ranging from 15° to 45° C., more preferably at 30° C., for the time necessary to develop a brown coloration, usually ranging from 0.5 to 7 days.

The extraction is carried out directly on the brown, ground beans, with water-ethanol solutions at concentration from 20 to 80% v/v, preferably from 40 to 60% v/v, at temperatures from room temperature to 80° C., preferably from 60° C. to 70° C., with extraction times from 70 to 100 minutes. The resulting extract is then evaporated to a total solids of about 35 to about 25% w/w. The concentrate is then diluted with water to a total solids ranging from 5 to 20% w/w and subjected to the enzymatic treatment.

The enzymatic system used according to the invention is characterized by marked cellulase activity, ranging from 2000 to 6000 IU/g, preferably from 3000 to 5000 IU/g, most preferably of 4000 IU/g. This enzymatic system differs from the enzymes cited in the prior art (which are often used in complex mixtures of different types) in its higher overall lytic activity, which allows the use of very low concentrations, even 0.1-0.3% on the fresh bean, or less. This is undoubtedly an advantage, not only as far as industrial feasibility and costs are concerned, but also for the reproducibility of the resulting product.

The enzymatic lysis to release vanillin can be carried out in a non-sterile environment, in a thermostated tank equipped with a stirrer (e.g. an anchor stirrer) with continuous, mild stirring or in a static condition, or with intermittent stirring. The reaction is carried out at temperatures ranging from 25° C. to 50° C., preferably from 30° C. to 40° C., for a time ranging from 20 to 72 hours, preferably from 24 to 40 hours. An amount of enzyme with cellulase activity of 2000-6000 IU/g, equivalent to 0.05÷0.4% on the fresh material, preferably 0.1÷0.3%, is added. The pH of the mixture can range from 3.5 to 5.5, preferably from 4 to 5. The transformation can be monitored by TLC or HPLC and is carried out until an appreciable increase in the desired components is observed.

The purification (step b) finally involves the purification of the soft aqueous extract by treatment with hydroethanolic solutions of different alcoholic degrees or with a 50% v/v hydroethanolic solution, obtained by diluting the enzymatically treated extract with ethanol, operating at temperatures ranging from room temperature to 50° C. The obtained hydroethanolic fractions are combined and concentrated under vacuum, at temperatures not above +45° C., to obtain a thick aqueous concentrate.

The resulting product can be further purified using small volumes of concentrated ethanol.

More concentrated and purified products can be obtained by means of further purification treatments, such as extractions with ethyl acetate or replacements with alcohol mixtures.

The analysis of the intermediate steps and of the final product for the vanillin contents can be carried out by TLC and HPLC.

TLC analysis is suitably carried out using Silica Gel 60F254 plates (Merck), eluent system: 85:15 chloroform-methanol, UV detection at 254 nm; subsequent reaction with reactive CAS (cerium ammonium sulfate dihydrate, ammonium molybdate tetrahydrate, concentrated sulfuric acid) and observation of the bands under visible light.

HPLC analysis can be suitably performed using Zorbax Eclipse XDB-C18® columns (250×4.6 mm) 5 μm, in 0.3% H₃PO₄/acetonitrile 95:5-10:90 linear gradient, flow 1 ml/min, λ 254 nm, run time 55 min.

The determination of the total solids of the intermediates and of the final product can be conveniently carried out by incubating aliquots of the samples in a oven at +105° C. for 15 hours. Alternatively, a moisture analyzer (for example: Sartorius model MA100) can be used, setting the analysis temperature at +105° C.; the percent total solids of the sample is determined when a weight loss lower than 1 mg/60 seconds is recorded.

The quality of the extract is evaluated from both the organoleptic and instrumental standpoint by measurement of L*, a*, b*, YIE313 coordinates (CIELAB coordinates) according to USP26/NF20<1061>. CIELAB color coordinates of the final product can be suitably determined with a calorimeter (for example: HunterLab model ColorFlex). The color of the final product is determined on dilutions at 5.0% w/w of total solids, using 50% v/v ethanol as diluent.

The final product obtainable according to the process of the invention has a content in vanillin of 4.2-8.5 g per kg of starting green beans, and superior organoleptic characteristics than the products obtainable with the methods of the prior art.

The process of the invention is illustrated in greater detail in the following examples.

### EXAMPLE 1

1) Extraction

The green beans are frozen at −20° C., brought and kept for 7 days at a temperature of 4° C. (browned beans; 139 kg, having 1.19% w/w Vanillin Glucoside and 0.10% w/w Vanillin contents), then ground through a 4.5 mm grid and loaded in a percolator. The plant material is exhaustively extracted with 50% v/v ethanol. The first extraction is carried out with an amount of 95% v/v ethanol calculated on basis of the beans moisture content (about 80% w/w) as to obtain a 50% v/v alcoholic degree solution (i.e. 124 liters). The subsequent extractions (totally 8) are performed with a volume of 50% v/v ethanol (expressed in liters) equivalent to the weight of the ground plant material (expressed in kg) (i.e. 139 liters). Each extraction is carried out at a temperature of +70° C. and with a contact time of 90 minutes. The resulting hydroethanolic percolates are pooled and concentrated under vacuum at +30° C. to obtain a thick soft concentrate (36 kg, 27% w/w total solids) which is stabilized by addition of ethanol to obtain a 20% v/v alcoholic degree (% calculated on the water content) and stored at +4° C. until usage for the biotransformation.

2) Enzymatic transformation

Before the biotransformation, the ethanol present is removed from the intermediate concentrate by means of two replacements with water. The resulting concentrate is diluted with water to obtain a 10% total solids solution. The solution is added with the enzyme Cellulosin AC40 (HBI Enzymes Inc.), in an amount of approx. 0.2% w/w on the ground plant material. The bioconversion (95 liters of reaction mixture in 250 liters reactor) is carried out at +40° C. for 48 hours under mild stirring. After completion of the transformation, the suspension is concentrated under vacuum at +30° C. and stabilized by addition of ethanol (20% v/v on the water present), to obtain a soft residue of 29 kg with 9.4 kg dry residue.

3) Depuration

The 20% v/v water-ethanol concentrate is diluted with 95% v/v ethanol to obtain a 50% v/v ethanol water-alcohol solution (% based on the water present). The diluted mixture is kept under stirring at +45° C. for about an hour, then left to settle at room temperature and finally filtered. The filtration residues are taken up with water and homogenized at +45° C., diluted with ethanol to 60% v/v alcoholic degree and left to settle overnight at room temperature. The water-alcohol solution is subsequently filtered. The water-alcoholic solutions are combined and concentrated under vacuum at a temperature of +45° C. until obtaining a thick aqueous concentrate. Keeping temperature at +45° C. and under stirring, 95% v/v ethanol is added until homogeneity and anyway until reaching a final alcoholic degree not lower than 20% v/v.

The process yielded 6.29 g of Vanillin per kg of processed plant material, corresponding to 93.7% of total Vanillin calculated for the plant material (6.72 g per kg of plant material, as sum of free Vanilllin and glucoside bound Vanillin).

### EXAMPLE 2

1) Extraction

The green beans (198.6 g, with 1.12% w/w Glucoside Vanillin and 0.05% w/w Vanillin contents) are soaked for 3 minutes in water pre-heated to +60° C. After scalding, the beans are incubated at +30° C. for 5 days, during which the plant material grows dark brown. After completion of the incubation the observed weight loss is 16%. The browned beans (166.7 g) are ground, adjusted to 50% v/v alcoholic degree (obtained adding 147 ml of 95% v/v ethanol) and placed in a heating jacket percolator. The plant material is exhaustively extracted with 50% v/v ethanol. 550 ml of 50% v/v ethanol is used for each extraction (totally 9). Each extraction is carried out at a temperature of +70° C. and with contact time of 100 minutes. The resulting hydroalcoholic percolates are combined and concentrated under vacuum at +45° C., to obtain a thick soft concentrate (33.1 g, 36.4% w/w total solids).

2) Enzymatic transformation

The resulting concentrate is diluted with water until obtaining a 20% w/w total solids solution. The solution is added with the enzyme Cellulosin AC40 (HBI Enzymes Inc.), in an amount of approx. 0.2% w/w on the ground plant material. The bioconversion is carried out at +40° C. for 72 hours under mild stirring.

3) Depuration

After completion of the transformation, the reaction is quenched by addition of 95% v/v ethanol in such an amount as to adjust the alcoholic degree to 50% v/v. The extract is concentrated under vacuum at +45° C. for about one hour, to obtain a thick soft residue. 26.9 g of extract with 33.9% w/w total solids are obtained.

The process yielded 5.06 g of Vanillin per kg of processed plant material, corresponding to 85.5% of total Vanillin calculated for the plant material (5.92 g per kg of plant material, as sum of free Vanilllin and glucoside bound Vanillin).

### EXAMPLE 3

1) Extraction

The frozen green beans (2117 g, with 1.19% w/w Vanillin Glucoside and 0.10% w/w Vanillin content) are kept for 0.5 days at a temperature of +4° C. After completion of the incubation, during which the plant material thaws and grows dark brown, the observed weight loss is 7.6%. The browned beans (2006 g) are ground through a 4.5 mm grid, added with 1800 ml of 95% v/v ethanol and placed in a percolator at room temperature. The plant material is extracted for 80 minutes, then the first extraction is collected. The plant material is exhaustively extracted with 50% v/v ethanol. The subsequent extractions (totally 5) are carried out with a volume of 50% v/v ethanol (expressed in liters) equivalent to the weight of the ground plant material (expressed in kg) (i.e. 2 liters). Each extraction is carried out at room temperature with a contact time of 80 minutes. The resulting hydroalcoholic percolates are pooled and concentrated under vacuum at +45° C., to obtain a thick soft concentrate (265 g, 53.8% w/w total solids).

2) Enzymatic transformation

The resulting concentrate is diluted with water to obtain a 20% w/w total solids solution. The solution is added with the enzyme Cellulosin AC40 (HBI Enzymes Inc.) in an amount of approx. 0.2% w/w on the ground plant material. The bioconversion is carried out at +50° C. for 47 hours under mild stirring. After completion of the transformation, the reaction is quenched by addition of 95% v/v ethanol in such an amount as to adjust the alcoholic degree to 50% v/v (the volume added, expressed in ml, is equivalent to 0.89 times the weight of the reaction mixture, expressed in g).

3) Depuration

The diluted mixture is kept under stirring at +45° C. for about an hour, then left to settle at room temperature and finally filtered. The filtration residues are taken up with water and homogenized at +45° C., diluted with ethanol to 60% v/v alcoholic degree and left to settle overnight at room temperature. Finally the hydroalcoholic solution is filtered through paper filter. The hydroalcoholic solutions are combined and concentrated under vacuum at a temperature of +45° C. until obtaining a thick aqueous concentrate. Keeping temperature at +45° C. and under stirring, 95% w/w ethanol is added until homogeneity and anyway until a final alcoholic degree not lower than 20% v/v.

The process yielded 6.45 g of Vanillin per kg of processed plant material, corresponding to 72.0% of total Vanillin calculated for the plant material (8.96 g per kg of plant material, as sum of free Vanilllin and glucoside bound Vanillin).

### EXAMPLE 4

1) Extraction

The green beans are frozen at −20° C. (350 kg, with 1.32% w/w Vanillin Glucoside and 0.10% w/w Vanillin contents) ground through a 4.5 mm grid and placed in a percolator. The ground plant material is exhaustively extracted with 50% v/v ethanol. The first extraction is carried out with an amount of 95% v/v ethanol calculated on basis of the beans water content (approx. 80% w/w) to obtain a 50% v/v alcoholic degree solution (i.e. 311 liters). The subsequent extractions (totally 8) are carried out with a volume of 50% v/v ethanol (expressed in liters) equivalent to the weight of the ground plant material (expressed in kg) (i.e. 350 liters). Each extraction is carried out at a temperature of +70° C. and with a contact time of 90 minutes. The resulting water-alcoholic percolates are combined and concentrated under vacuum at +30° C., to obtain a thick soft residue (92.5 kg, 26.3% w/w total solids) which is stabilized by addition of ethanol to obtain a 20% v/v alcoholic degree (% calculated on the water present) and stored at +4° C. until usage for the bioconversion.

2) Enzymatic Transformation

Before the biotransformation, the ethanol present is removed from the intermediate concentrate by means of two substitutions with water. The resulting concentrate is diluted with water to obtain a 10% total solids solution. The solution is added with the enzyme Cellulosin AC40 (HBI Enzymes Inc.), in an amount of approx. 0.2% w/w on the ground plant material. The bioconversion (240 liters of reaction mixture in a 1000 liters reactor) is carried out at +40° C. for 44 hours under mild stirring. After completion of the transformation, the suspension is concentrated under vacuum at +30° C. and stabilized by addition of ethanol (20% v/v on the water present), to obtain a soft concentrate of 63 kg with a dry residue of 24 kg.

3) Depuration

The 20% v/v hydroalcoholic concentrate is diluted with 95% v/v ethanol to obtain a 50% v/v hydroalcoholic solution (% based on the water content). The diluted mixture is kept under stirring at +45° C. for about an hour, then left to settle at room temperature and finally filtered. The filtration residues are taken up with water and homogenized at +45° C., diluted with ethanol to 60% v/v alcoholic degree and left to settle overnight at room temperature. The water-alcohol solution is subsequently filtered. The hydroalcoholic solutions are combined and concentrated under vacuum at a temperature of +45° C. to obtain a thick aqueous concentrate. Keeping temperature at +45° C. and under stirring, 95% v/v ethanol is added until homogeneity and anyway until a final alcoholic degree not lower than 20% v/v.

The process yielded 6.96 g of Vanillin per kg of processed plant material, corresponding to 94% of total Vanillin calculated for the plant material (7.40 g per kg of plant material, as sum of free Vanilllin and glucoside bound Vanillin).

### EXAMPLE 5 (COMPARATIVE EXAMPLE-METHOD EP 0 555 466)

The green beans (220 kg, with 1.24% w/w Vanillin Glucoside and 0.10% w/w Vanillin contents) are ground through a 4.5 mm grid.

A 1000 liters percolator is loaded with a water volume (expressed in liters) equivalent to twice as much the weight (expressed in kg) of the ground plant material (i.e. 440 liters), containing the enzyme Cellulosin AC40 (HBI Enzymes Inc.) in an amount of 0.2% w/w on the plant material. The ground plant material is placed in the percolator equipped with a recirculation system. The bioconversion is carried out at +40° C. for 24 hours.

The reaction mixture is percolated and the percolate (506 kg) is added with 500 liters of 95% v/v ethanol to obtain a 50% v/v ethanol solution. The plant material is continuously, exhaustively extracted with 50% v/v ethanol at +70° C., to obtain fivehydroethanolic fractions of 200 liters each and (totally 1000 liters).

The two (aqueous and hydroalcoholic) percolates are kept separated and concentrated at a temperature of approx. 30° C. under vacuum. After that, each concentrate is added with ethanol to reach a 20% v/v alcoholic degree on the water present.

The following concentrates are obtained:
1. water-ethanol concentrate from aqueous extractions (37.4 kg with 10 kg dry residue)
   2. water-ethanol concentrate from water-ethanol extractions (30.6 kg with 3.5 kg dry residue)

The resulting products are mixed and concentrated by evaporation of the solvent.

The process yielded 4.29 g of Vanillin per kg of processed plant material, corresponding to 61.3% of total Vanillin calculated for the plant material (7.00 g per kg of plant material, as sum of free Vanilllin and glucoside bound Vanillin).

### EXAMPLE 6

1) Determination of the Final Products Total Solidss

The following procedure is followed for each soft extract from examples 1 to 5: approx. 1 g aliquot of each extract is homogeneously distributed on a plate (equipped with glass fiber filter) and accurately weighed on a moisture analyzer; the heating program is set at +105° C. and the weight loss of the sample is recorded as a function of time; the sample weight is considered constant when its weight loss rate is lower than 1 mg/60 sec; the percent total solids (TS %) is calculated as the ratio of the final weight to the initial weight.

The recorded values for the products of examples 1 to 5 are reported in the following table 1:

TABLE 1

| Sample | Example 1 | Example 2 | Example 3 | Example 4 | Example 5 |
|---|---|---|---|---|---|
| TS % | 51.0 | 33.9 | 43.7 | 57.2 | 58.8 |

2) Determination of CIELAB Color Coordinates

An aliquot of each extract from examples 1 to 5 is diluted with 50% v/v ethanol to obtain a solution with 5.0% w/w total solids. The solutions are analyzed with a colorimeter (HunterLab, model ColorFlex) to determine the L*, a*, b*, YIE313 coordinates according to USP26/NF20<1061>.

3) Organoleptic Analysis of the Final Products

An aliquot of each extract from examples 1 to 5 is diluted with 50% v/v ethanol to obtain a solution with vanillin content of 1.0% w/w (HPLC assay); each hydroethanolic solution is evaluated for the olfactory organoleptic properties. Aliquots of 1.0 g and less (until the perception threshold) of each dilution are further diluted to 50 g with sugared whole milk (5% w/w saccharose). The milk dilutions are evaluated for the taste organoleptic properties.

The following table 2 summarizes the results of the analysis:

TABLE 2

| | Step a) | | | | |
|---|---|---|---|---|---|
| Sample | (browning) | Smell | Taste | After-taste | YIE313 |
| Example 1 | yes | ++ | ++ | none | 164.50 |
| Example 2 | yes | ++ | ++ | none | 175.06 |
| Example 3 | yes | ++ | ++ | none | 191.88 |
| Example 4 | no | + | + | perceptible | 225.28 |
| Example 5 | no | + | + | perceptible | 222.09 |

The reported data evidence that values of YIE313<200 correspond to organoleptically better extracts than those with values of YIE313>200. In particular, comparison between examples 1-3 and examples 4-5 shows that the browning step provides an improvement in the organoleptic quality and the simultaneous decrease in the YIE313 value.

1. A process for the preparation of a vanilla extract, which comprises the following steps:
a) browning of the beans;
b) extraction of the beans followed by treatment with an enzymatic system with cellulase and hemicellulase activities;
c) purification of the products to a vanillin-enriched concentrate.

2. A process as claimed in claim 1, in which the browning of the beans is carried out by means of a cycle of freezing at temperatures ranging from −10 to −30° C. and thawing at temperatures ranging from 20 to 8° C.

3. A process as claimed in claim 1, in which the browning of the beans is carried out by means of a cycle of scalding in water at temperatures ranging from 60° to 65° C. and subsequent incubation at temperatures ranging from 15° to 45° C.

4. A process as claimed in claim 1, in which the extraction is carried out with hydroethanolic solutions of an alcoholic degree ranging from 20 to 80% v/v, at temperatures ranging from room temperature to 80° C.

5. A process as claimed in claim 4 in which the extraction is carried out with hydroethanolic solutions of an alcoholic degree ranging from 40 to 60% v/v, at temperatures ranging from 60° to 70° C.

6. A process as claimed in claim 1, in which the enzymatic treatment is carried out by contacting the extract with enzymes having cellulase activity ranging from 2000 to 6000 IU/g.

7. A process as claimed in claim 6, in which an enzyme with activity ranging from 3000 to 5000 IU/g is used.

8. A process as claimed in claim 7, in which an enzyme with cellulase activity of 4000 IU/g is used.

9. A process as claimed in claim 6, in which the enzyme is used in concentrations ranging from 0.05 to 0.4% on the fresh bean.

10. A process as claimed in claim 6, in which the reaction is carried out at temperatures ranging from 25° C. to 50° C., for a time ranging from 20 to 72 hours.

11. A process as claimed in claim 1, in which the purification (step b) comprises a series of treatments with water-ethanol solutions of different alcoholic degrees for the depuration of the aqueous soft extract or of a 50% v/v hydroalcoholic solution obtained by ethanol dilution of the enzyrmatically treated extract, operating at temperatures ranging from room temperature to 500 C.

12. A process as claimed in claim 2, in which the enzymatic treatment is carried out by contacting the extract with enzymes having cellulose activity ranging from 2000 to 6000 IU/g.

13. A process as claimed in claim 3, in which the enzymatic treatment is carried out by contacting the extract with enzymes having cellulase activity ranging from 2000 to 6000 IU/g.

14. A process as claimed in claim 4, in which the enzymatic treatment is carried out by contacting the extract with enzymes having cellulose activity ranging from 2000 to 6000 IU/g.

15. A process as claimed in claim 5, in which the enzymatic treatment is carried out by contacting the extract with enzymes having cellulase activity ranging from 2000 to 6000 IU/g.

16. A process as claimed in claim 7, in which the enzyme is used in concentrations ranging from 0.05 to 0.49% on the fresh bean.

17. A process as claimed in claim 8, in which the enzyme is used in concentrations ranging from 0.05 to 0.4% on the fresh bean.

18. A process as claimed in claim 7, in which the reaction is carried out at temperatures ranging from 25° C. to 50° C., for a time ranging from 20 to 72 hours.

19. A process as claimed in claim 8, in which the reaction is carried out at temperatures ranging from 25° C. to 50° C., for a time ranging from 20 to 72 hours.

20. A process as claimed in claim 2, in which the purification (step b) comprises a series of treatments with water-ethanol solutions of different alcoholic degrees for the depuration of the aqueous soft extract or of a 50% v/v hydroalcoholic solution obtained by ethanol dilution of the enzymatically treated extract, operating at temperatures ranging from room temperature to 50° C.
